(19) United States
(12) Patent Application Publication
(10) Pub. No.: US 2006/0275915 A1
(43) Pub. Date: Dec. 7, 2006

(54) Method and apparatus for mixing sample and reagent in a suspension fluid

(75) Inventors: Stephen J. Sowerby, Dunedin (NZ); Graham W. Batts, Dunedin (NZ); Diana F. Hill, Dunedin (NZ)

Correspondence Address: FOLEY AND LARDNER LLP;SUITE 500, 3000 K STREET NW, WASHINGTON, DC, 20007, US

(73) Assignee: Global Technologies (NZ) Ltd.

(21) Appl. No.: 10/550,547

(22) PCT Filed: May 7, 2004
(86) PCT No.: PCT/NZ04/00086

§ 371 Date: Aug. 10, 2006

(30) Foreign Application Priority Data
May 16, 2003 (NZ) 525969

(51) Int. Cl. G01N 1/00

(52) U.S. Cl. 436/174

(57) ABSTRACT

Discrete samples (13, 13a) are introducedinto a mixing chamber containing a carrier fluid (5), so that the samples (13, 13a) move from an inlet (4) to an outlet (7) of the mixing chamber. One or more reagents (12, 12a, 14, 14a) are also introduced into the mixing chamber, which move from the inlet (4) to contact and mix with the corresponding samples (13, 13a) at a location (15) in the mixing chamber, to form respective processed samples (16, 16a, 16b, 16c) for further processing or analysis. The location of contact (15) is predetermined by predetermining the rate of movement of the samples (13, 13a) and of each reagent (12, 12a, 14, 14a). The method and apparatus permit rapid automated processing, are suitable for very small sample and reagent volumes (eg, 100 nanolitres), and minimize contamination.

### FIELD OF INVENTION

This invention relates to a method for processing samples and an apparatus for carrying out the method. In particular, the method relates to the mixing of discrete samples in a carrier medium with one or more reagents prior to analysis of the samples, where the samples and reagents are immiscible with the carrier medium. The invention can be used in relation to any sample processing in which mixing of samples with one or more reagents is required, for example the processing of biological samples. The invention has particular application to the automated processing of successive samples.

### BACKGROUND

In many fields of technology, samples to be investigated or analysed must firstly be processed to enable analysis of the sample. For example, when DNA extracted from plant or animal matter requires analysis, the DNA sample must first be mixed with reagents that commence DNA specific chemical reactions. The processed DNA samples can then be analysed as required. In addition to DNA analysis, there are many tests that samples of biological material may undergo. Samples of non-biological material also are often required to be subjected to analysis for a vast range of reasons. Generally, any type of analysis of a biological or non-biological sample will require at least some type of processing to mix each sample with one or more reagents needed for the analysis.

Further, it is often necessary to investigate a large number of samples and to analyse many samples within certain time constraints. It is therefore desirable to use a process which is at least partially automated.

Sample processing techniques are known where discrete samples travel through an apparatus in a medium where they are maintained separately from each other and are mixed with reagents before an analysis step. However, each suffers from disadvantages or problems.

U.S. Pat. No. 4,853,336 (Saros et al.) describes a continuous flow fluid handling system In which carryover contamination of successive liquid samples is minimised by the use of a fluid in which the samples are immiscible. The liquid samples flow through a conduit that is wetted by and coated in a film of the fluid, thereby minimising contamination of the apparatus. Contaminaton between each successive liquid sample is minimised by introducing a gas bubble between the successive samples to prevent their coalescence. A wash liquid is also introduced to reduce contamination and so the result is a stream of alternating gas and liquid segments. Mixing of successive liquid segments occurs by removing the occluding air bubble.

However, the use of air bubbles in this system introduces a level of complexity that it is not desirable. For instance, special processes are required both to introduce and to remove air bubbles and these must be capable of handling a range of specific bubble sizes at crucial times. Furthermore, air bubbles can behave in unpredictable ways and so there is potential for an occluding air bubble to be incompletely removed, which would in turn prevent coalescence of the sample and a reagent and therefore no mixing event or reaction would take place. The utility of this system is further limited because it is not suited for sample processing involving more than two stages of sample contacting reagents. In addition, the presence of many segments of air, fluid, and sample increases the processing time of the successive samples.

The flushable low carryover container desribed in U.S. Pat. No. 5,192,504 (Cassaday and Valhalla) enables successive containment and mixing of discrete liquid samples with minimum contamination of the container. This is achieved by constructing the container with materials that are wettable by an isolation liquid introduced to the container to form an independently flowing isolation liquid stream. The stream covers the walls of the container from its inlet to its outlet, thereby preventing contact by the liquid samples with the container walls. The container is preferably fabricated from fluorinated hydrocarbon solid materials to achieve wettability. The isolation fluid is preferably made from fluorinated or perfluorinated hydrocarbons. However, such materials represent a significant expense. In addition, a smooth transition from container inlet to container outlet without any ‘hidden’ spaces or reverse taper or curvature is of paramount importance for the proper functioning of the isolation liquid stream. This places onerous requirements on the precision fabrication of the container.

Furthermore, the container of U.S. Pat. No. 5,192,504 requires that one discrete liquid sample must be completely drained from the container outlet before a second discrete liquid sample is introduced into the container for processing. This need for complete drainage reduces the rate at which samples can be processed. The container is designed for processing relatively large reaction volumes (e.g. in the millilitre range), and consequently is not well-suited for handling very small reaction volumes (e.g. in the microlitre range). Furthermore, the container and the method of using it depend on the container being open to the atmosphere. This increases the likelihood of contamination of the container contents by way of air-borne contaminants, and increases the likelihood of evaporation of the discrete liquid sample in the container. In many sample processing applications, the avoidance of any contamination is imperative. The utility of this invention is further limited because it is not suited for sample processing that requires two or more stages of sample contact with reagents.

Other devices or systems are described in EP 0047130, EP 0081116, and U.S. Pat. No. 4,582,687.

There is a need for sample processing techniques and apparatus that enable the mixing and processing of two or more successive samples In a manner that does not lead to samples touching the surface of the processing apparatus, and does not lead to contamination between successive samples.

It is therefore an object of this invention to provide a sample processing method and apparatus which goes at least some way to avoiding any one or more of the abovementioned problems or disadvantages, or at least provides a useful alternative.

### STATEMENTS OF INVENTION

In one aspect of the invention there is provided a method for producing a sample for processing or analysis including the following steps:
a) introducing the sample into a mixing chamber containing a suspension fluid, where the sample is either in solid form or is in liquid form immiscible with the suspension fluid, so that the sample moves from an inlet to an outlet of the mixing chamber; and
b) introducing one or more reagents into the mixing chamber, where the one or more reagents are either in solid form or are in liquid form immiscible with the suspension fluid, so that each of the reagents move from the inlet and contact the sample at a location in the mixing chamber before the sample reaches the outlet of the mixing chamber;

where the location of contact between the sample and the one or more reagents in the mixing chamber is predetermined by predetermining the rate of movement of the sample and of each reagent, and where the sample mixes with the one or more reagents upon contact to form a processed sample for further processing or analysis.

In a preferred embodiment of the invention, the rate of movement of the sample and of each reagent in the suspension fluid of known density is predetermined by selecting the size and density of the sample and/or the size and density of each reagent.

Preferably, the rate of movement of the sample and the rates of movement of each reagent are such that the sample contacts and mixes with each reagent as it moves in the mixing chamber.

Preferably, the mixing chamber has a tapered portion to assist contact of the sample with each reagent by causing the sample and each reagent to converge as they move in the mixing chamber.

In one preferred embodiment of the invention, the sample contacts and mixes with a single reagent as it moves in the mixing chamber. In an alternative preferred embodiment, the sample contacts and mixes with two or more reagents in the mixing chamber. Preferably the two or more reagents contact and mix with the sample at substantially the same time. Alternatively, the rates of movement of the sample and of each of the two reagents are predetermined so that the sample contacts and mixes with a first reagent and then contacts and mixes with a second reagent, and optionally with further reagents successively.

In a preferred embodiment of the invention, the mixing chamber is orientated vertically. The sample and the one or more regents may be introduced at or near to the top of the mixing chamber and descend in the suspension fluid. Alternatively, the sample and the one or more regents may be introduced at or near to the bottom of the mixing chamber and ascend in the suspension fluid.

The sample may be any sample suitable for the method of the invention, but is preferably an extract from a biological sample selected from the group including, but not limited to, blood, serum, semen, saliva, urine, milk, and an extract obtained from meat, fat, bone, hair, skin, faeces, plant material or microbial habitats, or is preferably a non-biological sample selected from the group including, but not limited to, water from waterways, industrial wastes, and hazardous or non-hazardous chemicals, including radioactive materials.

The one or more reagents may be any reagent suitable for the processing and/or analysis of the sample, but are preferably selected from the group including Tris buffer, water, magnesium chloride, an oligonucleotide, a DNA template, a deoxyribonucleoside triphosphate, and a thermostable DNA polymerase.

The suspension fluid may be any fluid within which the sample and the one or more reagents are immiscible. However, the suspension fluid is preferably a hydrocarbon oil, such as paraffin.

Preferably, the introduction of the one or more reagents is controlled by detecting the introduction of the sample and sending a signal to a device controlling the introduction of the one or more reagents.

Preferably, the flow rate of suspension fluid through the mixing chamber is regulated. More preferably, the suspension fluid is introduced into the mixing chamber to maintain a constant level within the mixing chamber.

When the sample or the one or more reagents are in solid form each, independently of the other, is preferably a coated magnetised bead or a lyophilised mass of solid.

In a second aspect of the invention there is provided an apparatus for carrying out the method of the first aspect of the invention including:
a) a mixing chamber;
b) one or more inlets for introducing a suspension fluid into the mixing chamber;
c) one or more inlets for introducing a sample for processing or analysis into the mixing chamber;
d) one or more inlets for introducing one or more reagents into the chamber; and
e) an outlet to enable a processed sample to exit the mixing chamber.

The apparatus preferably further includes a device downstream of the outlet for analysing the processed sample. Preferably the device is a PCR thermocycler, a spectrophotometer, a fluorescence detector, an incubator or reaction chamber, a chemiluminescence detector, a bioluminescence detector, a scintillation counter, a diverter, a sorter, or a fraction collector.

In one embodiment of the invention the apparatus has two or more mixing chambers connected in series.

Preferably, the apparatus includes a detector to detect the introduction of the sample and a device to receive a signal from the detector where the device controls the introduction of the one or more reagents.

Preferably, the apparatus includes a detector to detect the level of the suspension fluid and a device to receive a signal from the detector where the device controls the introduction of the suspension fluid to maintain a constant level.

Preferably, the mixing chamber is closed to the atmosphere and the mixing chamber is under a positive pressure to assist the flow of the suspension fluid from the suspension fluid inlet to the outlet. Alternatively, the mixing chamber is open to the atmosphere and a negative pressure is applied to the outlet of the apparatus to assist the flow of the suspension fluid from the suspension fluid inlet to the outlet.

Preferably the outlet is integrally formed with an outlet conduit having a bore diameter preferably in the range of 50 μm to 10 mm. Alternatively, the outlet is an opening adapted for connection to an outlet conduit having a bore diameter preferably in the range of 50 μm to 10 mm.

It is also preferred that the sample and each of the one or more reagents is introduced to the mixing chamber using a co-axial injector having an inner bore from which the sample or each reagent is introduced into the mixing chamber and an outer layer containing suspension fluid where suspension fluid flows from the outer layer into the mixing chamber in a manner which assists each sample or reagent to move from the end of the inlet into the mixing chamber.

### BRIEF DESCRIPTION OF FIGURES

FIG. 1 is a schematic diagram of a mixing apparatus according to the invention.

FIGS. 2a to 2d show a method of the invention in which the sample undergoes two stages of contact and mixing with reagents.

### DETAILED DESCRIPTION

The invention has been described where the apparatus is arranged in a vertical or inclined manner so that the samples and reagents descend within the suspension fluid. However, the apparatus may be operated in a manner where the samples and reagents are less dense that the suspension fluid and ascend in the mixing chamber (rather than descend). It is also to be appreciated that an alternative orientation of the apparatus, such as horizontal, may be adopted and a positive or negative pressure is applied to the mixing chamber to control the movement and contact of samples with reagents.

The invention is described below by way of example only. The examples are not to be taken as limiting the invention in any way. Furthermore, it is to be appreciated that the method and apparatus of the invention may be implemented in various forms. It should also be appreciated that the invention may be applied In a range of applications that require a sample to be mixed with reagents.

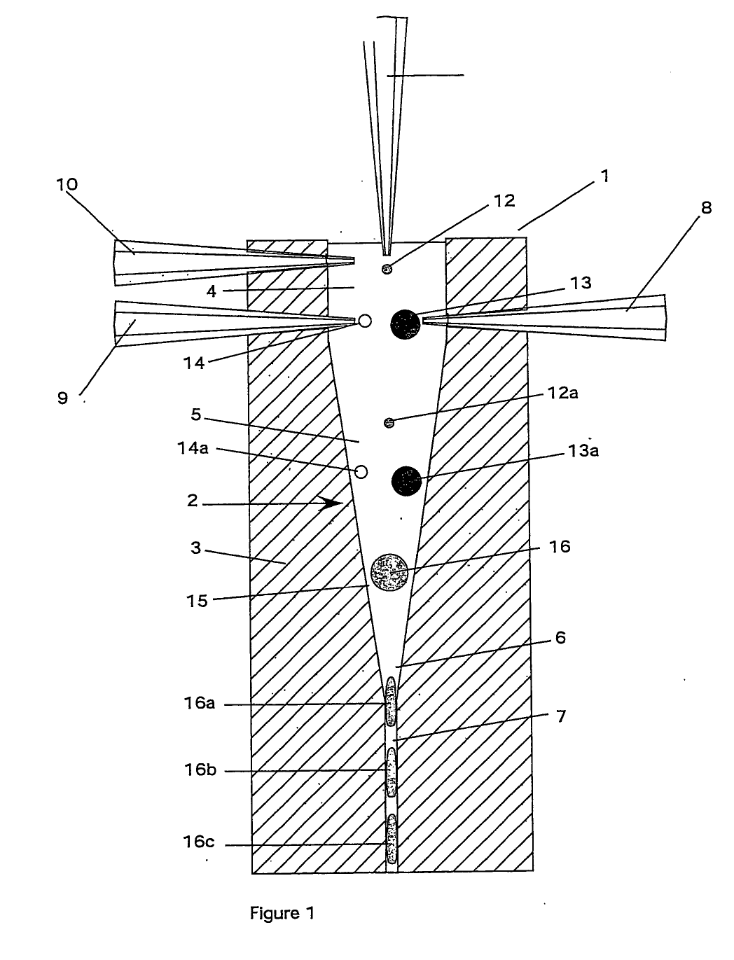

FIG. 1 shows a sample processing apparatus according to the invention. The apparatus 1 has a mixing chamber 2 embedded in a transparent solid block 3. While a solid block is the preferred means of supporting the mixing chamber 2, any other suitable means of support may be used. The solid block 3 is preferably made of a plastics material, such as acrylic. The mixing chamber 2 is preferred to be a micro-pipette tip or a similarly tapered hollow device embedded in the solid block 3. The mixing chamber 2 includes a main body 4 connected to a tapered portion 5. The tapered portion 5 has an outlet 6 connected to an outlet conduit 7. The outlet 6 and the outlet conduit 7 each have a bore diameter typically in the range 50 μm to 10 mm. The outlet 6 is shown embedded in the solid block 3. However, the outlet may protrude from the solid block in an alternative construction of the apparatus. The outlet conduit 7 enables processed samples to be transferred to a location for analysis or further processing, as required.

The main body 4 of the mixing chamber 2 includes inlet ports 8, 9, 10, and 11, each located proximal to the upper end (when in use) of the apparatus 1. Two inlet ports 8 and 9 are for introducing reagents into the mixing chamber 2, while inlet port 10 is for filling the mixing chamber 2 with a suspension fluid. Inlet port 11 is for introducing one or more samples into the mixing chamber 2. The number and positioning of inlet ports 8, 9, 10, and 11 can be adapted as required depending upon the number and nature of the samples and reagents that are required for the analysis.

Prior to mixing samples with reagents, the mixing chamber 2 is filled with a degassed suspension fluid that is immiscible with the reagents and samples. The suspension fluid is introduced through inlet port 10. One preferred suspension fluid is paraffin oil. The suspension fluid is continually replenished as required thereby creating a flow of suspension fluid from the inlet port 10 to the outlet 6. The level of suspension fluid is detected with a suitable detection system and this sends a signal to a device that controls the introduction of the suspension fluid into the mixing chamber.

As will be appreciated by those skilled in the art, the reagents will be selected depending upon the nature of the sample, and the type of reaction or testing to be carried out on the sample. The term “reagent” is intended to cover any chemical, whether biological or non-biological and whether synthetic or non-synthetic, required for the processing or analysis being undertaken on the samples, and includes, but is not limited to, enzymes, catalysts, diluents, buffers, and enzyme co-factors.

In turn, the suspension fluid will be selected depending upon the nature of the reagents and samples. The reagents and samples are in solid form or are in liquid form immiscible with the suspension fluid. Typically, the reagents and samples will be aqueous liquids, solutions or suspensions, and the suspension fluid will be an oil or oil-like hydrophobic liquid, such as a paraffin. The suspension fluid will be of sufficient density or buoyancy to, at least partially, suspend the reagents and sample and allow control over the rate of descent of the reagents and samples in the mixing chamber 2.

Examples of solid form reagents include coated magnetic beads and lyophilised solid masses. Magnetised beads can be coated in a range of reagents that can be chosen to facilitate the binding of sample components to the bead after the sample and bead contact each other. The magnetic properties can be exploited to control the movement of the bead within the suspension fluid and/or in subsequent processing or analysis of the processed sample. Lyophilised solid masses can be used as a convenient way to introduce pre-prepared aliquots of reagent. They may be advantageous in continuous automated processing of samples if the reagents in lyophilised form have a longer shelf life. They are designed to dissolve on contacting a sample and/or other reagents within the mixing chamber.

FIG. 1 shows a sample 12 introduced into the mixing chamber 2 via the sample inlet port 11. The sample and reagent volume can vary in size, but is typically in the nano-litre to micro-litre range depending on the processing requirements. The sample 12 may be Introduced into the mixing chamber 2 by any suitable manual or robotically controlled method. Reagents 13 and 14 are shown introduced via inlet ports 8 and 9, respectively. One way to introduce small volumes is to utilise a co-axial injector which consists of an inlet port surrounded by a constant stream of suspension fluid which assists the small volume of sample or reagent to move away from the end of the inlet port into the mixing chamber. The sample 12 and the reagents 13 and 14 drift towards a mixing point 15 typically under the influence of gravity primarily and to a lesser extent the flow of the suspension fluid. As the sample 12 and reagents 13 and 14 approach the mixing point 15, the influence of the walls of the tapered portion 5 causes the sample 12 and the reagents 13 and 14 to come into contact and mix to form the reaction mixture 16.

The timing of the introduction of the sample 12 and reagents 13 and 14 is controlled, preferably by a computer control system. The timing is predetermined to ensure that the sample 12 and the reagents 13 and 14 arrive at the mixing point 15 in the desired sequence and at the desired time. For example, it may be necessary for the sample 12 and reagents 13 and 14 to arrive at the mixing point substantially simultaneously to ensure that the mixing of sample 12 and reagents 13 and 14 takes place effectively. To do this, the computer control system will utilise information on the rate of descent of the sample 12 and reagents 13 and 14 through the suspension fluid to calculate the required introduction times and ensure that their arrival times at the mixing point 16 coincide. The length of the mixing chamber 2, the chamber pressure (if applicable), and the densities and volumes of the suspension fluid and of the sample 12 and reagents 13 and 14 are some of the parameters that may be utilised for determining the introduction times.

The rate of descent of samples and reagents is affected by the flow rate of the suspension fluid which is in turn affected by the position within the tapered portion 5 of the mixing chamber 2. The suspension fluid has a slower rate at the walls of the tapered portion 5 and a faster rate at the centre of the tapered portion 5. The rate of descent of the samples and reagents is also affected by their densities and volumes. For instance, a large sample droplet may descend comparatively quickly until it is slowed by the slow moving suspension fluid at the walls of the tapered portion 5. Conversely, small sample droplets may descend comparatively slowly until they reach the fast moving suspension fluid at the centre of the tapered portion 5. The densities of samples and reagents can be altered by adding substances such as sucrose or glycerol. The viscosity of the suspension fluid can also be controlled by adjusting the temperature of the suspension fluid. These are some factors that allow substantial flexibility in controlling the rates of descent of samples and reagents.

At the mixing point 15, the sample 12 and reagents 13 and 14 contact and mix so that the desired chemical or biological reaction is initiated and discrete processed sample 16 is formed. The processed sample 16 then exits the mixing chamber 2 through the outlet 6 and the outlet conduit 7 flowing in the stream of the suspension fluid. The processed sample 16 can then be transferred to other apparatus as required, for further processing or analysis, or for storage, as required.

The invention is best suited to the successive processing and analysis of multiple samples. Samples 12 are introduced into the mixing chamber 2 one after the other at regular time intervals and at a predetermined frequency. Reagents 13 and 14 are introduced into the mixing chamber 2 at the same frequency so that each sample 12 and each reagent 13 and 14 descend into the tapered portion 5 (shown as sample 12a and reagents 13a and 14a) and converge to form processed sample 16 at the mixing point 15. As each processed sample 16 moves into the outlet conduit 7 an amount of suspension fluid separates each processed sample 16 (shown as processed sample 16a, 16b and 16c) maintaining the integrity of each processed sample 16 for further processing or analysis. In this way, a continuous sample processing and analysis operation can be carried out.

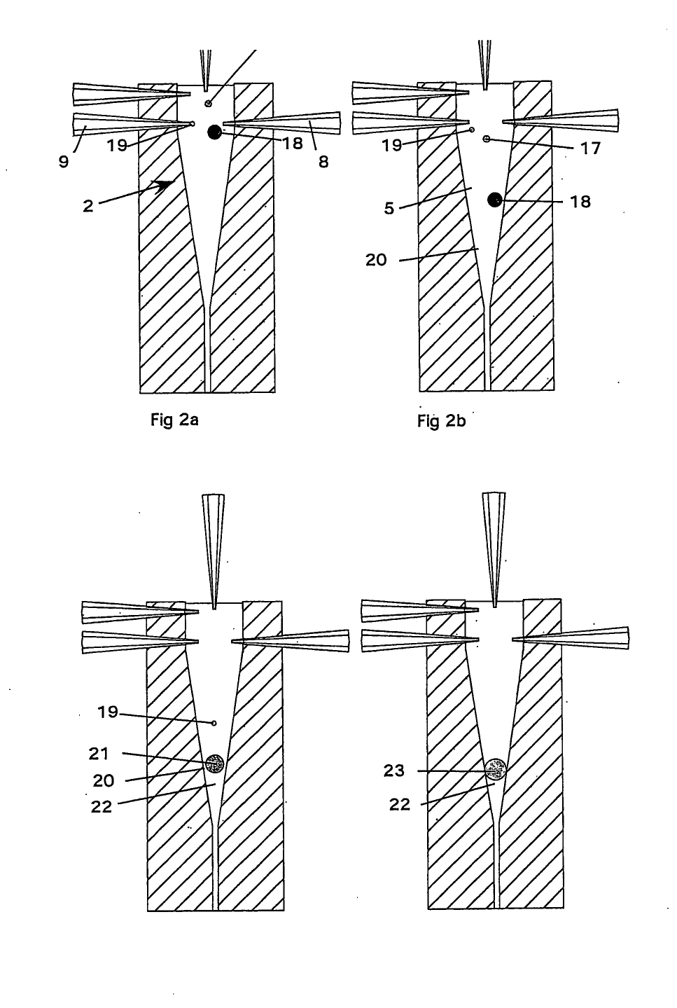

The method described above relies on the convergence of samples and reagents at the mixing point 15 near the bottom of the tapered portion 5 of the mixing chamber 2, and is particularly suited to sample processing requiring a single stage. An alternative method of the invention is shown in FIGS. 2a to 2d and relates to sample processing requiring two or more stages where it is desirable to mix the sample with one reagent before one or more subsequent reagents are allowed to make contact and mix with the sample at one or more subsequent mixing points. The effect is a cascade of mixing events that occur in a predetermined sequence as the sample descends in the mixing chamber 2.

Sample processing involving two or more stages is shown in FIGS. 2a to 2d. FIG. 2a illustrates a sample 17 being introduced into the mixing chamber 2 via the sample inlet port 11. Reagents 18 and 19 are also introduced via the reagent inlet ports 8 and 9, respectively. Once introduced, the sample 17 and the reagents 18 and 19 then descend towards the lower end of the tapered portion 5 (as shown in FIG. 2b). The timing of introducing the sample 17 and the reagents 18 and 19, and the size and density of each, is predetermined so that the sample 17 contacts and mixes with reagent 18 at mixing point 20 to form intermediate processed sample 21 (as shown in FIG. 2c). Reagent 19 then contacts and mixes with intermediate processed sample 21 at mixing point 22 to give processed sample 23 (as shown in FIG. 2d). FIGS. 2a to 2d show one possible arrangement for sample processing involving two stages. It is to be appreciated that the method can be adapted to sample processing involving more than two stages. It is also to be appreciated that other methods of coordinating the sequence and timing of contact and mixing of samples and reagents are possible using the method and apparatus of this invention.

The method and apparatus of the invention are considered to be well-suited to the automated sequential testing or processing of multiple samples, whereby multiple samples for testing, as well as appropriate reagents, are introduced into the mixing chamber in a time controlled sequential manner.

One possible application of the invention is in the analysis of biological samples from the chain line of a high throughput food processing plant. In many food processing operations, quality control and a tracking system relating the origin of a food product to its destination are imperative. DNA testing is one method of carrying out food assurance. For example, in the meat processing industry, DNA testing can be used to discriminate between individual animals in large populations, and to link animals with their products, their parents, and their environment (such as the farm of origin, the presence of animal or bacterial diseases, and the GE status of the animal).

More particularly, DNA analysis of each animal is desirable to enable labelling and later identification of the parents of the animal, or products that come from the animal. DNA extracted from a sample (e.g. blood, skin, hair) taken from each animal can be introduced in sequence into the mixing chamber filled with a suspension fluid such as paraffin oil. Reagents are then introduced at predetermined times and combine with each sample in sequence to create processed samples. The processed samples are then transferred through the outlet to a PCR apparatus for further processing and analysis. The ability of the invention to enable a single sample to undergo multiple or sequential mixing events has particular relevance for DNA analysis where it is beneficial to have some reagents mixed with the sample prior to the addition of others.

A range of tests may be carried out on each processed sample. For example, the DNA In each processed sample could be inspected to detect specific DNA fingerprints or other DNA identifiers for pathogenic microbes, production traits in farm animals, deliberate genetic modification, and the like. Further, DNA mutations could be detected, and more specifically nucleotide polymorphisms, to form the basis of a tracking system to track animal products back to the place of origin. Additionally, samples may be tested for the presence of agrochemicals that animals may have come into contact with and for any specific meat characteristics.

Other applications of the invention include:
analysis of human biological samples, particularly where large population sampling or mass screening is required,
tracking the origin of, and determining the quality of, food or non-food biological commodities,
environmental testing for pathogens, industrial contaminants, and the like,
disease surveillance infrastructures for rapid monitoring of human and animal disease outbreaks,
human, plant and animal forensics, and
testing of hazardous materials.

Samples can be taken from any source, such as body fluids (e.g. blood, serum, semen, saliva, milk), from environmental sources, such as waste water (testing for contamination) and waterways (testing for algal blooms), and from processed samples of meat, fat, bone and the like. Samples can be partially processed by other means before being introduced into the apparatus.

The speed with which the method of this invention can operate provides a particularly significant financial advantage. The method and the apparatus of the invention as part of an automated system are compatible with rapid sampling in a food processing plant. The speed of operation depends principally on the time required for a processed sample, once formed, to exit into the outlet, thereby making way for another processed sample to follow. The speed of exit can be as little as one per second and can be adjusted by controlling the rate at which the suspension fluid flows from the mixing chamber. Furthermore, there is no requirement that the first sample (and reagent/s) has exited the mixing chamber before the next sample (and reagent/s) is introduced.

Another advantage of the invention is the avoidance of expensive fluorinated hydrocarbon materials for either the mixing chamber fabrication or the suspension fluid. Cheap readily available paraffin oil is the preferred suspension fluid of the invention.

A further advantage of the invention is its suitability for processing very small sample and reagent volumes, for example as small as 100 nl. Furthermore, because the apparatus can be fully enclosed and because samples and reagents are fully immersed in the suspension fluid, there is no possibility of evaporation of sample or reagent liquids. This is particularly significant when handling very small samples, or when handling volatile reagents.

A key feature of the invention is the minimisation of contamination of samples. Samples do not touch any surface of the apparatus that is wetted by the suspension fluid, and contamination between successive samples is virtually eliminated. The need for washing the apparatus between samples is essentially eliminated. Potential contamination can be further minimised or mopped up by introducing droplets of a cleaner fluid which includes but is not limited to buffer or water or a chelating agent.

The ability to process the sample by mixing with reagent in multiple or sequential mixing events is an advantage for many applications. There is no need to flush a mixing chamber or have a series of conduits as is required by some previously known methods and apparatus. Furthermore, some known sample processing methods require the use of many disposable pipette tips or reaction tubes. The method and apparatus of the invention minimises the need for these and therefore the associated costs and disposal problems.

Although the invention has been described by way of example, it should be appreciated that variations and modifications may be made without departing from the scope of the invention. Furthermore, where known equivalents exist to specific features, such equivalents are incorporated as if specifically referred In this specification.

### INDUSTRIAL APPLICABILITY

The method and apparatus of this invention are useful for a wide variety of sample testing and analysis applications. These include analysis of human biological samples, particularly where large population sampling or mass screening is required, tracking the origin of, and determining the quality of, food or non-food biological commodities, environmental testing for pathogens, industrial contaminants, and the like, disease surveillance infrastructures for rapid monitoring of human and animal disease outbreaks, human, plant and animal forensics, and testing of hazardous materials.

1-34. (canceled)

35. A method for producing a sample for processing or analysis comprising:
a) introducing a sample into a mixing chamber containing a suspension fluid, wherein the sample is either in solid form or is in liquid form immiscible with the suspension fluid, so that the sample is a discrete sample immersed in the suspension fluid, and wherein the sample moves from an inlet to an outlet of the mixing chamber; and
b) introducing one or more reagents into the mixing chamber, wherein the one or more reagents are either in solid form or are in liquid form immiscible with the suspension fluid, so that each of the reagents is a discrete reagent immersed in the suspension fluid, and wherein each of the reagents moves from the inlet and contacts the sample at a location in the mixing chamber before the sample reaches the outlet of the mixing chamber;
wherein the location of contact between the sample and the one or more reagents in the mixing chamber is predetermined by predetermining the rate of movement of the sample and of each reagent within the suspension fluid, and wherein the sample mixes with the one or more reagents upon contact to form a processed sample for further processing or analysis.

36. A method as in claim 35 wherein the rate of movement of the sample and of each reagent in the suspension fluid of known density is predetermined by selecting the size and density of the sample and/or the size and density of each reagent.

37. A method as in claim 35 wherein the rate of movement of the sample and the rates of movement of each reagent are such that the sample contacts and mixes with each reagent as it moves in the mixing chamber.

38. A method as in claim 35 wherein the mixing chamber has a tapered portion to assist contact of the sample with each reagent by causing the sample and each reagent to converge as they move in the mixing chamber.

39. A method as in claim 35 wherein the sample contacts and mixes with a single reagent in the mixing chamber.

40. A method as in claim 35 wherein the sample contacts and mixes with two or more reagents in the mixing chamber.

41. A method as in claim 40 wherein the two or more reagents contact and mix with the sample at substantially the same time.

42. A method as in claim 40 wherein the rates of movement of the sample and of each of the two reagents are predetermined so that the sample contacts and mixes with a first reagent and then contacts and mixes with a second reagent, and optionally with further reagents successively.

43. A method as in claim 35 wherein the mixing chamber is orientated vertically.

44. A method as in claim 43 wherein the sample and the one or more reagents are introduced at or near to the top of the mixing chamber and descend in the suspension fluid.

45. A method as in claim 43 wherein the sample and the one or more reagents are introduced at or near to the bottom of the mixing chamber and ascend in the suspension fluid.

46. A method as in claim 35 wherein the sample is an extract from a biological sample selected from the group consisting of blood, serum, semen, saliva, urine, and milk.

47. A method as in claim 35 wherein the sample is an extract obtained from meat, fat, bone, hair, skin, faeces, plant material or a microbial habitat.

48. A method as in claim 35 wherein the sample is a non-biological sample selected from the group consisting of water from waterways, industrial wastes, and hazardous or non-hazardous chemicals, including radioactive materials.

49. A method as in claim 35 wherein the one or more reagents are selected from the group consisting of Tris buffer, water, magnesium chloride, an oligonucleotide, a DNA template, a deoxyribonucleoside triphosphate, and a thermostable DNA polymerase.

50. A method as in claim 35 wherein the suspension fluid is a hydrocarbon oil.

51. A method as in claim 50 wherein the hydrocarbon oil is paraffin.

52. A method as in claim 35 wherein the introduction of the one or more reagents is controlled by detecting the introduction of the sample and sending a signal to a device controlling the introduction of the one or more reagents.

53. A method as in claim 35 wherein the flow rate of suspension fluid through the mixing chamber is regulated.

54. A method as in claim 35 wherein the suspension fluid is introduced into the mixing chamber to maintain a constant level of the suspension fluid within the mixing chamber.

55. A method as in claim 35 wherein the sample is in liquid form immiscible in the suspension fluid.

56. A method as in claim 35 wherein the sample is in solid form.

57. A method as in claim 56 wherein the sample is a coated magnetized bead or a lyophilized mass of solid.

58. An apparatus for producing a sample for processing or analysis comprising:
a) a mixing chamber;
b) one or more inlets for introducing a suspension fluid into the mixing chamber;
c) one or more inlets for introducing a sample for processing or analysis into the mixing chamber;
d) one or more inlets for introducing one or more reagents into the chamber; and
e) an outlet to enable a processed sample to exit the mixing chamber.

59. An apparatus as in claim 58 further including a device downstream of the outlet for analyzing the processed sample.

60. An apparatus as in claim 59 wherein the device is a PCR thermocycler, a spectrophotometer, a fluorescence detector, an incubator or reaction chamber, a chemiluminescence detector, a bioluminescence detector, a scintillation counter, a diverter, a sorter, or a fraction collector.

61. An apparatus as in claim 58 further comprising a second mixing chamber connected in series to a first mixing chamber.

62. An apparatus as in claim 58 further comprising a detector to detect the introduction of the sample and a device to receive a signal from the detector wherein the device controls the introduction of the one or more reagents.

63. An apparatus as in claim 58 further comprising a detector to detect the level of the suspension fluid and a device to receive a signal from the detector wherein the device controls the introduction of the suspension fluid to maintain a constant level.

64. An apparatus as in claim 58 wherein the mixing chamber is closed to the atmosphere and the mixing chamber is under a positive pressure to assist the flow of the suspension fluid from the suspension fluid inlet to the outlet.

65. An apparatus as in claim 58 wherein the mixing chamber is open to the atmosphere and a negative pressure is applied to the outlet of the apparatus to assist the flow of the suspension fluid from the suspension fluid inlet to the outlet.

66. An apparatus as in claim 58 wherein the outlet is integrally formed with an outlet conduit having a bore diameter in the range of 50 μm to 10 mm.

67. An apparatus as in claim 58 wherein the outlet is an opening adapted for connection to an outlet conduit having a bore diameter in the range of 50 μm to 10 mm.

68. An apparatus as in claim 58 further comprising a co-axial injector having an inner bore from which the sample or each reagent is introduced into the mixing chamber and an outer layer containing suspension fluid wherein suspension fluid flows from the outer layer into the mixing chamber in a manner which assists each sample or reagent to move from the end of the inlet into the mixing chamber.
